(19) United States
(12) Patent Application Publication
(10) Pub. No.: US 2014/0074702 A1
(43) Pub. Date: Mar. 13, 2014

(54) Metered Wireless Energy System

(71) Applicant: VRINGO LABS, INC., New York, NY (US)

(72) Inventors: Donald Michael KOSAK, Hilo, HI (US); Andrew K. Lang, New York, NY (US)

(73) Assignee: Vringo Labs, Inc., New York, NY (US)

(21) Appl. No.: 13/648,940

(22) Filed: Oct. 10, 2012

Related U.S. Application Data
(60) Provisional application No. 61/698,263, filed on Sep. 7, 2012.

(51) Int. Cl. H02J 17/00

(52) U.S. Cl. CPC H02J 17/00
USPC 705/40; 307/104; 700/297

(57) ABSTRACT

A system and method for metering the power delivered by broadcast or wireless power systems to extract value by power providers, venue operators, and others. There are three main components in the system, a transmitter, a receiver, and a coordinating system.

### RELATED APPLICATIONS

This application claims priority from U.S. Provisional Patent Application Ser. No. 61/698,263 which was filed on Sep. 7, 2012.

### BACKGROUND OF THE INVENTION

1. Field of the Invention

The present invention related to wireless power and more specifically to metering wireless power or tiered delivery of wireless power.

2. Description of the Related Art

The earliest appreciation of the problem of metering wireless power delivery surfaced in 1903 when it caused the withdrawal of funding for Nikola Tesla's Wardenclyffe tower energy broadcasting facility.

Current solutions rely on the very limited range of energy transmission and deliver power in an unmetered fashion. Those solutions offer no way for energy provider to extract value from the transfer of power. They also fail to address the issues as new technology makes longer-range transmission possible. Current advances in the state of the art allow for coverage of a small room, and ranges and efficiency levels of various forms of broadcast power are increasing at a rapid rate. In addition efficiencies of electronic circuits for computation, illumination, and other purposes is also increasing at a rapid rate.

Although various broadcast or wireless power systems exist, what is needed is a system and method for metering that power.

### SUMMARY OF THE INVENTION

One embodiment of the present invention leverages those advances and makes value extraction practical for power providers, venue operators, and others. Presently, there are no systems for metering the power delivered by broadcast or wireless power systems.

Wireless or broadcast energy, which includes at least electrodynamic induction, broadcast power/energy/electricity, resonant magnetic induction, and beamed power (magnetic, RF, microwave, laser) can be used to power electronic devices such as computers, televisions, small appliances, mobile devices, or lighting fixtures. It might also be used to power over the eye displays, illuminated clothing, or self-warming coffee mugs.

One problem with transmitted energy systems such as electrodynamic induction is that the electricity produced is unmetered. The unmetered nature of known systems might work well for an isolated residence, or single occupant office structure, but is problematic for situations like apartment dwellers, shared office structures and so on.

Another application for metered wireless power is when a mobile user enters an area such as a coffee shop, airport, office building, or other area where they would like access to power over the air. Metering provides for the creation of “convenience” electricity. For example, a user does not have to worry about plugging in a device to recharge it because they purchased a “broadcast power pass” at for their favorite coffee shop or local airport.

The mechanisms described herein can also provide for tiered delivery of electricity. For example, a mobile phone might allow calls using broadcast power for anyone within range, but only charge its batteries if the owner had a paid power plan. A higher tier plan might allow for “rapid charge” if the phone supported that feature.

One embodiment of the invention uses various “smart” appliances, networks, and tuned energy transceivers to allow for metering and smart management of power and devices.

One embodiment of the system enables value extraction at a reasonable level from something previously unmetered.

There are three main components in the system, a transmitter, a receiver, and a coordinating system. There may be variations of each of these components which contain subsets or supersets of the basic functionality described below.

Transmitter

In one embodiment, the transmitter is configured to perform at least one or more of the following:

Accept requests for power (possible for a duration or wattage level) from a device;

Authorize requests through a number of mechanisms. (i.e.: special IDs, tokens, credit/debit mechanisms, account number, serial or device numbers, etc.);

Provide pricing, load levels, and available times and negotiate an

Agreed operating level with receiving device;

Provide energy to a specific device (based on information from the coordinating system);

Provide additional signals to the receiving device to alter the functionality or behavior of that device. These signals may incorporate information from user, device, and/or provider profiles;

Record or relay usage data to one or more entities (for billing purposes, statistics, etc.);

Avoid “fraudulent” usage through a number of mechanisms including but not limited to identifying fraud by monitoring load at the transmitter and comparing it with reported load from receivers, tuned frequency hopping if needed (based on a pattern agreed upon between transmitter and authorized receivers), active antenna technology which articulates antenna structures to direct the induction field degrading overall service if the level of fraud reaches certain thresholds. It should be noted that this system is not a system to prevent all possibility of fraud, and that these fraud implementations are optional.

Receiver

The receiver components are configured in accordance with one or more embodiments. Three embodiments are initially disclosed, although various features from each embodiment can be combined to form other embodiments.

According to one embodiment, the receiver is a “smart” receiver configured to:

Identify a presence of a compatible transmitter;

Generate a request for power, possibly specifying a duration and load (watts) to a transmitter;

Negotiate available load, timing, and pricing based upon a device profile, or account profile. The device owner might want to accept a charge anytime they are in range of a “coffee co. Power2go” provider, as they have a monthly pass with that provider. They may also accept charges from any transmitter that will bill their credit card less than $2/hour. This profile and decision-making may happen internal to the device (for example, a smartphone with local processing and user interface capability), or external to the device (for example, a website might be used to configure a users power account.);

Receive energy from a transmitter;

Respond to additional signals from the transmitter to activate specific functionality or behaviors including but not limited to change a color, illuminate a light, go into “high performance mode”, charge the battery, don't charge the battery, display an advertisement, and the like.

Report usage to the transmitter. Usage includes, but is not limited to connection time, average load level, peak load level, current load level, and the like;

Respond to various fraud, denial, or interference events;

Relay load level and/or energy transfer efficiency rates to the transmitter; and

Accept requests to vary the “tuning” of the receiver.

According to one embodiment, the receiver is a “dumb” receiver configured to:

Broadcast a device ID in the presence of operating transmitter via near field communication, RFID, Bluetooth, or the like; and

Receive energy from a transmitter;

According to one embodiment, the receiver is an “active” receiver configured to:

Broadcast a device ID in the presence of operating transmitter via near field communication, RFID, Bluetooth, or the like;

Receive energy from a transmitter; and

Respond to additional signals from the transmitter to activate specific functionality or behaviors including, but not limited to change a color, illuminate a light, go into “high performance mode”, charge the battery, energize the heating coil, and display an advertisement.

Coordinating System

According to one embodiment, a coordinating system is configured to manage information sets around:

Device profiles: characteristics and capabilities of devices, other device specific information, ownership, and associated user or provider profiles;

User profiles: payment information, accounts, plans or programs, demographics, geolocation data, and other user specific information;

Provider profiles: rate and plan information, service areas, and other provider specific information;

In one embodiment, the coordinating system is centralized or operated as a federation of loosely connected or disconnected systems. For example, a utility company may operate a coordinating system and might provide power in a device agnostic fashion. A device manufacturer may operate a different coordinating system. A set of venues such as a major coffee shop chain might also run a coordinating system for its customers.

Coordinating systems may overlap containing devices, users, or providers that might also exist in other coordinating systems allowing a single device to be used in multiple contexts or areas.

The transmitter and receiver architectures each comprise hardware architecture and software architecture contained within a data processing component of the hardware architecture. The coordinator service is generally software and runs on standard data processing equipment. In one embodiment, the processing equipment is a computer with memory, storage, computation, and connectivity.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a system according to one embodiment of the invention;

FIG. 2 is a system according to one embodiment of the invention;

FIG. 3 is a flowchart of the primary operations that occur when a receiver enters the operational range of a transmitter;

FIG. 4 is a transmitter architecture according to one embodiment of the invention;

FIG. 5 is a receiver architecture according to one embodiment of the invention; and

FIG. 6 is a coordinator service architecture according to one embodiment of the invention.

### DETAILED DESCRIPTION OF THE PRESENTLY PREFERRED EMBODIMENTS

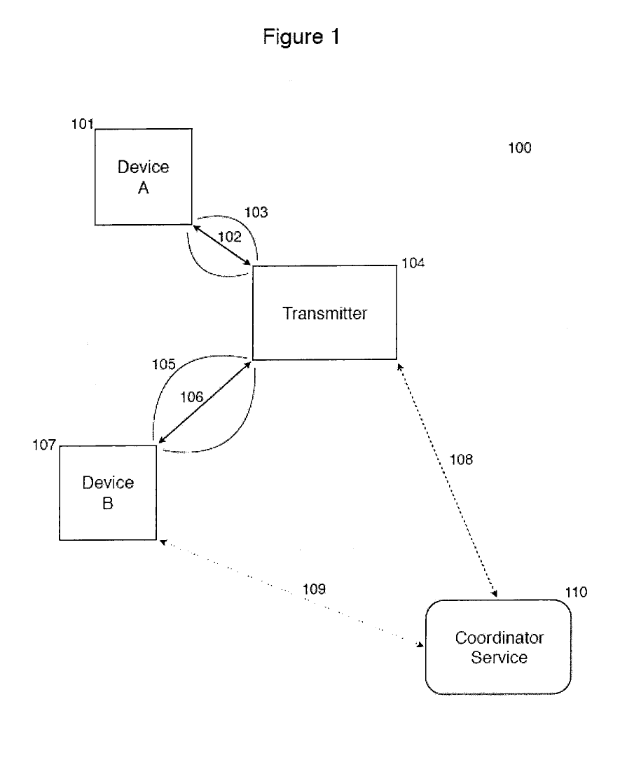

FIG. 1 is a system according to one embodiment of the invention. In FIG. 1, a transmitter provides power to two devices containing smart receivers as well as the communications between the transmitter, receivers, and a coordinating system. The two receivers are within the operational range of the transmitter. Each receiver has a device id. The transmitter can use information from the coordinating system to determine the level of service to provide to each receiver. The transmitter can deliver power, and encoded signals to each of these devices influencing the behavior of the receiving devices.

As shown, a transmitter 104 provides power to two devices 101, 107 that each comprises a smart receiver. Lines of communication 102, 106, 108, and 109 are shown between the transmitter 104, receivers 101, 107 and a coordinating system 110.

The respective receivers embedded in device 101 and 107 are within the operational range 100 of a transmitter 104. Each receiver has a device id. When a device enters the operational range 100 of a transmitter 104, the transmitter 104 can query the device ID of device 101, 107 (passively or actively) and take action based on that id.

Device 101 has entered the operational range 100 and exchanged a device ID with the transmitter over a communications link 102. This communications link may be bidirectional and/or multimodal for some devices, but this need not be the case, especially for simple devices. The mode of communications might be accomplished through passive or active RFID chip, or through technologies such as near field communication, Bluetooth, wifi, IR, a multimodal combination of these methods, or through other appropriate modes for the device.

The transmitter 104 preferably takes action based on internal rules or settings, cached rules, or active communications 108 with an external coordinator service 110. These actions include such behaviors as activating a power broadcasting signal 103, 105, or transmitting an encoded signal 102, 106 with the purpose of triggering a particular behavior or set of behaviors in the receiving device 101 107. These device behaviors might include selecting a service tier, activating certain features or capabilities.

The signal 102 may include ongoing data, such as weather information, flight information, or highly personalized information or advertisements. Device 107 in this has additional data communications capability and can connect 109 with a coordinator service 110. This connection might be “direct” or through a public network such as the Internet. Such a connection 109 can be used to negotiate different levels of service and/or to alter (add/edit/delete) information in the device or user profiles.

In the embodiment including multiple coordinator services 110, a device 101, 107 might query the transmitter 104 in range for the “address” of its coordinator service before making a connection. Device 101 does not have the capability to access a coordinator service 110 directly. It might still have the ability to negotiate levels of service and/or to alter information in the device or user profiles. In this case, such communications occur through the data link 102 with the transmitter 104 acting as an intermediary link 108 with the coordinator service 110.

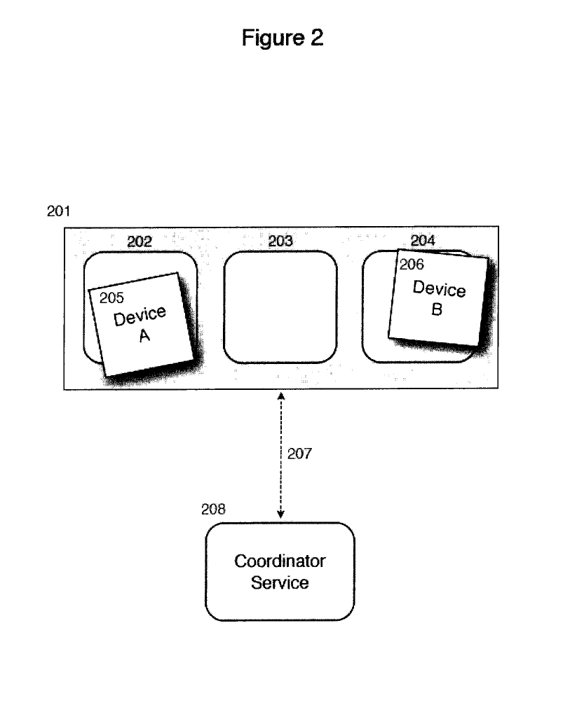

As shown in FIG. 2, a transmitter has a number of zones. Proximity of a receiver can be detected within a zone. In this diagram, a “dumb” receiver is in proximity to a particular zone. The ID of the receiver is checked against the coordinating system, and the zone is energized (or not) based on that check. This embodiment might be used for electric car charging stations, or “communal” charging stations for mobile phones or other devices.

Transmitter 201 has a plurality of zones 202, 203, 204. Proximity of a receiver contained with in the devices 205, 206 can be detected within a zone through technologies such as RFID, near field communication, Bluetooth, IR, and the like. The ID code of the receiver 205 is checked against the coordinating service 208 through an active communication link 207, and the respective zone 202 is energized (or not) based on that check.

It is also possible that internally codified rules or cached data within the transmitter 201 is used to determine whether the zone under a particular device is energized. For example, one such rule might be always energizing a zone when an ID from a particular manufacturer is detected. In the event cached data or internal rules are used, the coordinating service 208 and communications link 207 are optional.

In the embodiment of FIG. 2, a transmitter 201 detects device 205 with a device ID that satisfies its rule for authorized usage. The transmitter activates zone 202 supplying broadcast/inductive power to device 205. Continuing with this example, the transmitter 201 detects device 206 with a device ID that fails to satisfy its rule for authorized usage. The transmitter does not activate zone 204 and does not supply power to device 206. Similarly, no device is detected in the center zone 203 so that zone is not activated either.

This embodiment can be used for electric car charging stations, or “communal” charging stations for mobile phones or other devices. In the case of automobile charging stations, each zone 202, 203, 204 would represent parking spaces, and the devices 205, 206 would represent electric vehicles. In the case of a mobile device charging station, each zone 202, 203, 204 might be a pad of an appropriate size to hold a device 205, 206 such as a portable media player or mobile phone.

One advantage of the disclosed system is that it allows value to be extracted from the act of providing energy within a region. The value may be monetary, for example, a subscription fee, or consumption charges. The value might also be added convenience for customers or plan members.

In addition to simply metering power, this system enables tiered delivery. This allows specific features or behaviors to be enabled when interfaced with the system described in this document. Such behavior modification enables a much wider range of value extraction methods.

The transmitter generally only initiates a transfer of power if there is an authorized receiver near by. In one embodiment, a 2-way communication is used to negotiate with the transmitter to toggle power. Alternatively, simple one-way communication to passively or actively signal the transmitter for power is used.

For example, a travel mug might keep a beverage warm only in return for the continual display of advertisements. A small subscription fee or membership to a coffee loyalty program might allow the owner of the mug to instead display traffic alerts, or a family photo.

In addition to creating a value extraction stream, the embodiments described herein allow for the creation of entirely new devices and artifacts. For example, jewelry or clothing could be produced with a miniature power receiver that allows for intelligently controlled visual or auditory effects, or travel mugs could be created that warm or cool beverages when in a certain venue. Such devices can be sold at a lower cost, and subscription to power services would allow for their continued operation when traveling.

Homes may at some point in the future switch away from wired electric delivery for all but the largest appliances. All of the intelligent metered/tiered devices described could also function in a home. Members of the household would continue to pay for electricity as usual. Visitors (and possibly nearby neighbors) might be charged a token fee at the homeowners if they wish to use the broadcast power.

There is always a possibility to circumvent metering. The invention proposes several methods for limiting the effectiveness of these circumventions but does not completely remove the possibility. This problem is analogous to “cable theft”, or “power theft” and so on where a small minority of people will take extreme measures to circumvent metering.

Theft of service becomes less of a problem if metering systems become a standard and/or energy receiver components are manufactured with the requisite identifier and logic circuits as described in this document. Buying a phone, watch, or “travel mug” with such circuitry already embedded will be difficult to modify without damaging the aesthetic nature of the device. Many countries have laws against circumventing metering devices that should cover this type of system as well.

Another manner in which the disclosed system overcomes the “theft” problem is by providing tiered service. An energy “freeloader” will, by definition, have the lowest (no tier) of service. Devices built with this system can enable additional functionality based on authorized use.

In addition to the “smart” and “dumb” embodiments, it is possible to combine this system with the delivery of information or connectivity. Such a system might provide power to a mobile device while subsidizing the power by inserting advertisements into the data stream, or showing a video “commercial” upon initial connection. This invention can be used for inductive parking spaces for automobiles to recharge electric cars for example: the parking space having an embedded transmitter, and the car having an embedded receiver. Presence of an authorized receiver would activate the transmitter.

This invention could also be used for inductive device recharging “mats” to recharge mobile phones or other portable electronic devices. Presence of an authorized receiver would activate the transmitter. Mobile transmitters could be created which could be plugged into existing wired power outlets to provide convenient power for those nearby. Such transmitters could be metered as described in this document. The owner of the transmitter may chose to configure the device to accept payments, or to operate only with authorized devices.

Alternately, the manufacturer or distributor of the transmitter may choose to configure it in particular way, for example only providing power to devices of a certain brand or model, or only providing power users subscribing to a particular plan. Jewelry or fashion items could be embedded with this system and display various audio or visual effects using sensors for movement, proximity, position, etc.

A subscription fee or other mechanism could be used to allow these items to operate when in proximity to a transmitter. Information about the subscriber from the user profile or device profile might alter the behavior of the item. For example: the color of the item might change if the user is paying vs. free. A ring might glow pleasantly if registered to a paid user or have many customizable settings. The same ring if registered to an unpaid user might only illuminate dimly (or not at all).

Travel mugs with a receiver might keep your beverage at a constant warm temperature when at a participating coffee shop, or when used in a particular automobile. Again, a variety of plans and ways to extract value can be used. For example, an embedded display within the mug might show advertisements when activated for a non-subscriber. When activated for a subscriber, the same mug might show family photos, customized stock, weather information or news headlines.

In one embodiment, a user's gps/mapping device identifies nearby compatible power zones (if a car, smartphone, etc being charged). Detection and signaling is described through proximity electromagnetic signals like near-field, short range/Bluetooth radio, RFID, or light/laser/tag. Geo-awareness and mapping add a new dimension and provide unique applications and properties for the system.

In one embodiment, a user sits down in a location with a charging facility such as an airport, not realizing their phone needs to be charged and that he is within a power zone. The phone signals the user (vibrate or sound) to let them know. The user can then decide if, based on their own knowledge of when they will have a new opportunity to charge their phone, they should accept the energy price offered by the wireless energy provider. Similar situations exist for a car in parking in a space.

In one embodiment, when the device or phone/car/device is fully charged or has reached a certain level, it should let the user know with a sound, light, or remote signal. For example, you parked your car in a mall lot in a charging spot, and the car messages your phone when you have reached the desired level of charge so you can head back to your car.

In a preferred embodiment, there is some type of visual guidance for how to optimally orient or position device to maximize power transfer. For some types of devices, and some types of power transfer systems, this is a very compelling feature. For example, an indicator on the dashboard of your card could show you that you have parked too far to the left of the parking pad for optimal recharging. In one embodiment, the device uses the information to optimally orient itself. For example, a self-parking car could use the information to properly park itself for maximum charging efficiency. Alternatively, the charging pad could move to be optimally placed.

In one embodiment, a mobile phone may have an axis on its induction charging assembly that orients to the correct alignment to maximize charge. Alternately, it may have an arrangement of several receiving antennas and select from the antennas that provides the maximum energy transfer. Alternately a mems device could orient subelements of a receiver. In one embodiment, an active antenna design automatically orients itself.

In one embodiment, digital currency such as Bitcoins are used. Payment and/or barter by way of advertisement, loyalty, or the like are preferred. However, different payment and/or barter systems are possible.

When the device is totally discharged, enough energy needs to be transmitted without knowledge of whether payment is possible and acceptable so that device can power up and the metering process can execute. This small amount of billing computation energy can either be cost-free, or added to bill if user accepts. This prevents users from abusing the system to power/charge for free.

In one embodiment, a passive device/receiver ID is used. Thus, for devices that are fully discharged or “powered down” they react essentially act like the “dumb” receiver above.

In one embodiment, devices can share power and charge one another. For example, a first user's phone/car is fully charged, and another device is fully or mostly discharged. All of the devices have resonant tuning coils at the same frequency. In this manner, one device can transmit power to the lower powered device, even if it is just a small amount. Power could still be metered and paid for, allowing anyone to be a source of power for anyone else. This would also allow for “daisy-chaining” so that if, say, a power transmitter has a 10 foot radius at an airport gate, if enough people are using it, they can retransmit power to users further away so entire gate area can receive power.

Similarly, if two users are sitting near a transmitter and one user needs the power and the other user is fully charged and doesn't want the power nor to pay the cost, he also does not want to set off the “fraud” alarms that might shut down the transmittal of power for the first user, charging can be declined or accepted based on prestored criteria or settings or an active choice to accept or decline charging. If charging is declined, the second user's device should negotiate with the coordinator service to refuse the power, and “detune” its resonator. A physical disconnection halfway down the induction coil might achieve this so that it no longer resonated at the correct frequency. If this were not to happen, the coil would be forced to accept energy and dump it somehow.

In one embodiment, mems (microelectromechanical systems) create a wide variety of different receiver/antenna configurations that use mechanical systems to “tune/detune” or influence the transfer of power.

In one embodiment, a device being charged is configured to monitor and report an amount of charging current that is received.

In one embodiment, back-signaling is used to prevent fraud. The device arranges to pay transmitter for energy through coordination service. The transmitter can detect an amount of power being transferred in total in an area. The receiving device can refuse power via detuning. The device can thus let the transmitter know it is there and consuming power through a back encoded signal via a pattern of detuning and retuning. Otherwise it may be confusing for multiple devices and transmitters in an area to know if the device paying a particular transmitter is getting the agreed upon power from that transmitter. In one embodiment, a secondary information channel uses RFID, near field, and the like. In one embodiment, a signal is piggybacked on top of the transmitted power through sub-modulation or other mechanisms.

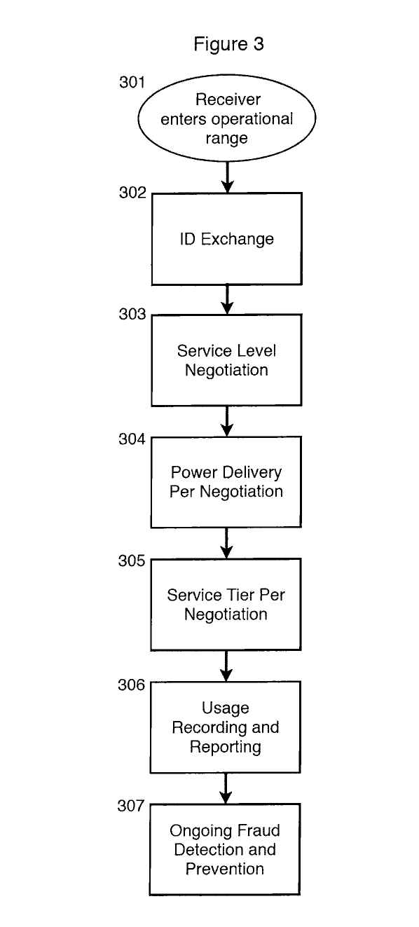

FIG. 3 is a flowchart of the primary operations that occur when a receiver enters the operational range of a transmitter according to one embodiment of the invention. In step 301, a receiver enters the operational range of a transmitter. Detection of the receiver enters the operational range of the transmitter event may happen in a number of ways, including, but not limited to proximity of an RFID chip, near field signal, magnetics, Hall sensors, mechanical pressure, optical sensor, radio wave signal, and the like. In step 302, ID exchange occurs. The ID exchange may be unidirectional or bidirectional, active or passive. In the case of unidirectional exchange, the transmitter acquires an ID from the receiver, as in the case of “dumb” receivers discussed above. In the case of bidirectional exchange, both the receiver and transmitter acquire the ID of the other, allowing a “smart” receiver to understand the capabilities of the transmitter and possibly make decisions based on that information. Active exchange occurs when the receiver device chooses to disclose its ID, possibly through a powered signaling method such as through a radio data link. Passive exchange occurs when the receiver discloses its ID automatically, possibly through an unpowered or always-on aspect such as an unpowered RFID chip, or barcode. Passive exchange allows for devices without internal power sources. For example, the device has a barcode that can be read by a barcode reader in one of the areas 202, 203, 204. Alternatively, an external barcode reader is provided that reads the device barcode. It might also be used for other devices, or in combination with active exchange modes to add flexibility such as allowing a “smart” receiver with no battery charge to bootstrap.

In step 303 a negotiation between a transmitter and receiver occurs. In one embodiment, the negotiation is entirely rule driven. Alternatively, the negotiation involves some user interaction. For example, in a rule-driven scenario, a negotiation might be as simple as “is a receiver present”, “is a receiver present with an authorized id”, or “is a receiver present with an authorized ID and an active billing account associated with that id”. A more complicated rule-driven scenario might include various conditions such as acceptable pricing ranges, current battery charge levels, and so on.

In an embodiment that includes user interaction, the user interaction may include a user asked to accept charges to their account, or to sign up for a “1 hour energy pass” by watching an advertisement. This negotiation may determine if power is delivered to a device as well as the tiered service level. This negotiation may occur locally between the transmitter and receiver, or between the transmitter, receiver, and a coordinator service. Each of the parties may have their own set of automated rules and conditions to drive the negotiation.

In step 304, power delivery occurs based at least in part on the outcome of the negotiation step 303.

In step 305, a service tier token is delivered based on the outcome of the negotiation step 303 for transmitters with tiered service support. In one embodiment, a data link is established to provide data or interactive services based on the tiered service level.

In step 306 for transmitters with usage reporting support, a usage record is generated for any device requesting services. In such cases, a report of that usage will be maintained. This report is maintained either locally, or in combination with a coordinator service.

In step 307 for a transmitter that is equipped for fraud detection, one or more of the ongoing fraud detection and prevention techniques described within this document are enacted.

It should be noted that the above steps can be implemented as required in a given system. Not all steps must be implemented for a given system, and only those steps required for a given implementation are performed.

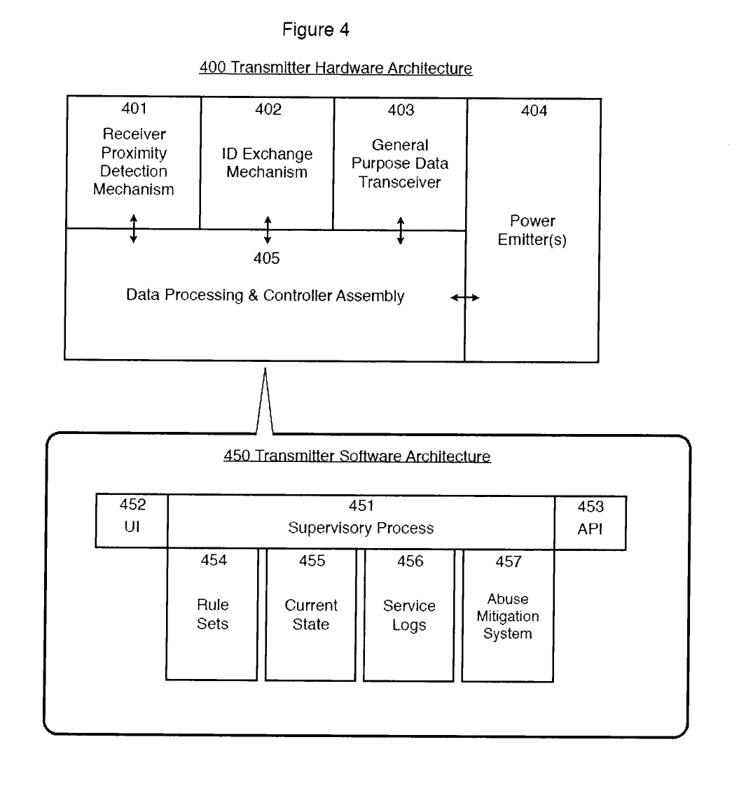

FIG. 4 is the primary hardware 400 and software 450 architecture for a transmitter according to one embodiment of the invention. The transmitter 400 includes a receiver proximity detection mechanism 401 for determining that a receiver is within operational range. The receiver proximity detection mechanism 401 can be implemented as a proximity of an RFID chip, near field signal, magnetics, Hall sensors, mechanical pressure, optical sensor, radio wave signal, and the like. An ID exchange mechanism 402 extracts the ID of a receiver, and optionally provides the ID of the transmitter. A data transceiver 403 allows data to be exchanged between the transmitter 400 and receiver or between the transmitter 400 and a coordinator service. Data transceiver 403 may be implemented in a number of ways including: radio link such as Bluetooth, wifi, optical link IR, laser, camera, acoustic link, ultrasonic, audio jack, or direct linkage, Ethernet jack, or USB.

In one embodiment, transmitter 400 operates in a “silent” mode without a transceiver 403, with transceiver 403 deactivated, or with transceiver 403 unable to establish a link. In such an instances, tiered service is not available only a default service level, and only basic negotiations using rules previously stored in data processing & controller assembly 405 are possible based on information provided by ID exchange mechanism 402.

Power emitter 404 delivers power to a device by one or more method including, but not limited to, broadcast beam, electrodynamic induction, and electromagnetic induction. The data processing & controller assembly 405 controls power emitter 404. In one embodiment, the power emitter 404 is capable of tuning to particular frequencies to link to individual or groups of receivers. Power emitter 404 preferably comprises an array of emitters and is capable of individually tuning and/or activating individual emitters.

Each of receiver proximity detection mechanism 401, ID exchange mechanism 402, transceiver 403, and power emitters 404 may share circuitry to accomplish their individual functions such as using power emitters 404 to detect a receiver, or to exchange ids.

The data processing & controller assembly 405 comprises of one or more CPU or similar logic controllers, working memory such as ram, storage including a disc or flash memory, and controllers to interface with receiver proximity detection mechanism 401, ID exchange mechanism 402, transceiver 403, and power emitters 404. The transmitter 400 can be implemented as discrete components or as a system on a chip.

The software architecture described 450 resides within transmitter 400. The software is stored on a nontransient computer readable medium. A supervisory process 451 responds to internal and external events such as the detection of a receiver, requests for services, rule-set update, or so forth. Supervisory process 451 coordinates the functions of the device controllers interfacing with the hardware 400. Supervisory process 451 also manages the user interface 452 and an application programming interface 453 for direct and remote access.

The transmitter software 450 includes rule-sets 454 for service delivery and service tiering, includes the ability to update rules from a coordinator service or make real-time requests from the coordinator service as per rule-set or on an as required basis. A registry or the like is configured as a current state information 455 that includes connected receivers, service levels, usage statistics, and possibly SNMP or other monitoring and quality of service interfaces.

Device or service logs 456 include diagnostics, costs, usage, QoS, and other operational details. In one embodiment, optional abuse detection and prevention algorithms 457 and associated working data are included.

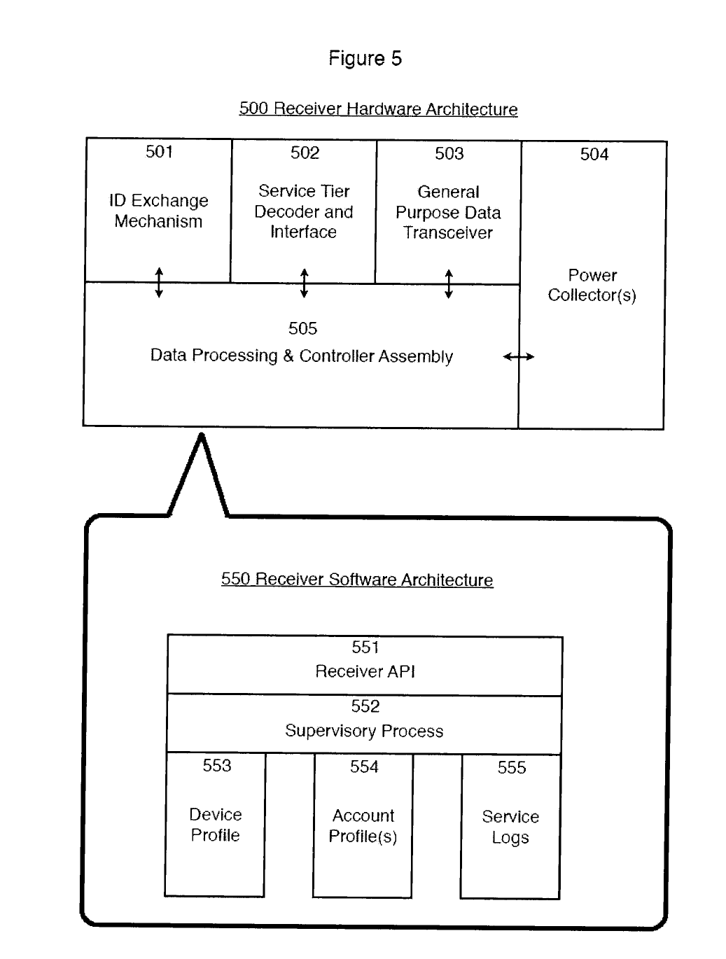

FIG. 5 shows the primary hardware 500 and software architecture 550 for a receiver. ID exchange mechanism 501 provides for the passive or active broadcasting of a receiver ID and possible reception of a transmitter id. Service tier decoder and interface 502 receives and/or decodes a service tier token. The service tier decoder and interface 502 may provide the service tier information via direct electrical signaling (ex: TTL level output, etc.) To the device incorporating the receiver, or might provide the information via a communications interface (ex: internal USB, RS232, etc.). If no service tier token is received, the default “no service tier” is assumed to be in effect. The service tier decoder and interface 502 component is only needed for devices that implement service tiers.

General-purpose data transceiver 503 is a data transceiver that allows data to be exchanged between the transmitter and receiver or between the receiver and coordinator service. General-purpose data transceiver 503 can be used during the negotiation stage to determine desired price and service levels. General purpose data transceiver 503 may also allow “smart” receivers with sufficient user interfaces to sign up for service plans or feature packages from coordinator services either directly or by way of a connected transmitter. General-purpose data transceiver 503 is only needed for devices that support active (two-way) negotiation, but can be present in any embodiment. In the event that no data transceiver is present, or if the transceiver is non-operational for any reason, negotiation responsibility is shifted to the ID exchange component 501.

The power collector 504 is configured to receive power through a variety of means such as broadcast, beam, electrodynamic induction, electromagnetic induction, and the like. Data processing & controller assembly 505 controls the power collector 504. The power collector 504 can be tuned to particular frequencies to link to a specific transmitter. ID exchange mechanism 501, service tier decoder and interface 502, transceiver 503, and power collector 504 may share circuitry to accomplish their individual functions such as using power collector 504 to exchange ids or receive service tier tokens via subcarrier modulation or other mechanism).

Data processing & controller assembly 505 comprises of one or more CPU or similar logic controllers, working memory such as ram, storage such as disc and flash memory, and controllers to interface with ID exchange mechanism 501, service tier decoder and interface 502, transceiver 503, and power collector 504. In one embodiment, the data processor need not have a CPU and/or memory. The data processing and control assembly can be implemented as a single transistor, or a custom programmable gate array and still provide control and/or UI. Data processing & controller assembly 505 may be implemented using discrete components or as a system on a chip. The software architecture 550 resides within data processing & controller assembly 505. It should be noted, that data processing & controller assembly 505 may be removed or greatly simplified to a simple logic controller. In one embodiment, the transceiver 503 and the data processor 505 are optional and not a requirement of the Receiver. The “dumb” receiver has neither. This allows for very lightweight receivers embedded in simple objects like a coffee mug or jewelry.

A receiver without a data processing & controller assembly 505 could rely on ID exchange mechanism 501 to fully implement the dumb receiver discussed above. Similarly, a receiver without a data processing & controller assembly 505, or with a very limited “logic only” data processing & controller assembly 505, could rely on the service tier decoder and interface 502 to fully implement an “active” receiver as shown above.

The receiver 500 provides an API 551 either directly through the data processing & controller assembly 505 or through the service tier decoder and interface 502. This API 551 allows for configuration of the characteristics of the receiver, including adding, modifying or removing: device profiles or accounts associated with the device as well as querying the logs. API 551 depends on a user interface provided by the device. This may be as sophisticated as a “Settings Screen” with an array of options, or as simple as a credit card reader slot, push button, or motion sensor.

A supervisory process 552 responds to receiver events such as the receipt of a negotiation request or service tier token as well as device events such as a battery level signal or geo fence. Supervisory process 552 coordinates the functions of the various device controllers interfacing with the receiver hardware 500 as well as to the device itself through the API 551 or directly through the data processing & controller assembly 505 or service tier decoder and interface 502 hardware interfaces. Supervisory process 552 has access to the various profiles, data-sets and rule-sets in Device Profile 553, Account Profile 554, and Service Logs 555.

Software module 553 contains data structures and algorithms to store and process rule sets and settings for power negotiation, service tiering and device specific modes of operation such as a low power mode, fast charge mode, and so forth.

Software module 554 contains data structures and algorithms to store and process service provider accounts. They may contain account identifier keys or other information specific to a service provider account such as expiration date, service plan, etc. If no matching plan is found, a device might optionally provide a mechanism to create an account. This might take the form of a sign up screen with an array of options, a light indicating that you should swipe a credit card, or other mechanism specific to the type of device.

Service logs 555 include diagnostics, usage, and other operational details. This information can be queried via the API 551 for incorporation into a device's user interface. The data could be used for diagnostics by device manufactures or service providers. The supervisor process to fine-tune the behavior of the Receiver can also use it.

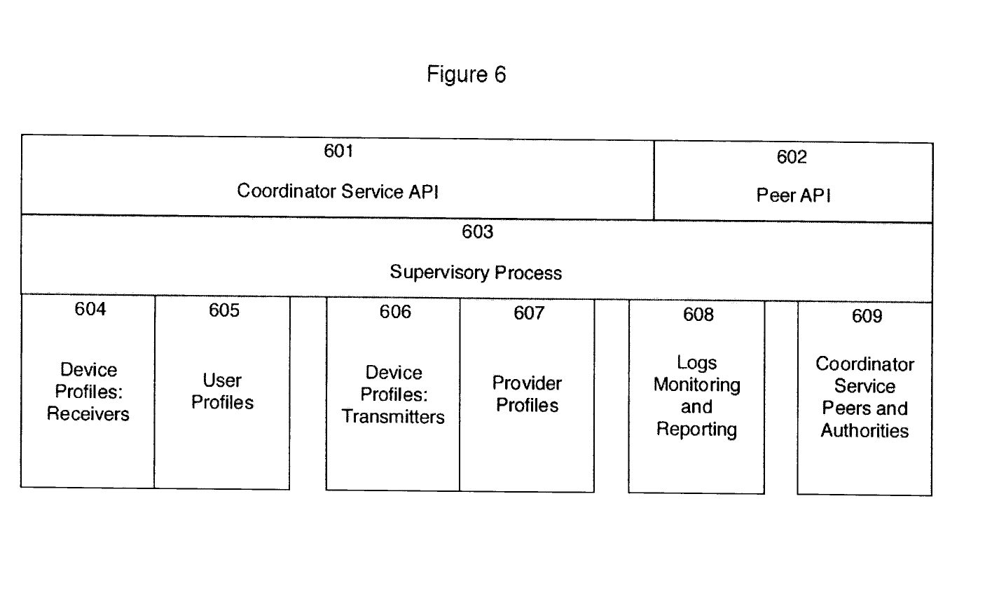

FIG. 6 is depicts the software architecture for a single coordinator service. It is possible for coordinator services to act in tandem with a central authority, as a federation of loosely connected services, or as disconnected system. The primary API 601 for the Coordinator Service handles requests and responses from Transmitters and Receivers. It can be made publicly available over a public network such as the Internet, or through a private network or secured private connection over public networks. The operator can choose to limit the scope of API 601 access to a Coordinator Service, for example: limiting it to only authorized peer Coordinator Services, limiting it only authorized Service Providers, limiting it to only authorized Users, and so on. The API 601 can also be used to create a public user interface for such tasks as locating service providers or setting up a portable user or device profile.

Peer API 602 provides for inter-Coordinator Service communications, data synchronization via push or pull, and general service coordination. This API 602 is typically private, but may provide certain services such as device information sharing to authorized “federated” Coordinated Services. For example, an operator might choose to federate two Coordinating Services at a Coffee Shop chain and Restaurant chain as it provides services to both. This would allow for selective sharing of data without merging the systems together.

Coordinator Service Supervisor 603 responds to API events 601, 602 and manipulates the various profiles and objects contained within 604, 605, 606, 607, 608, and/or 609 to construct a response. It is possible that a request will trigger an external API request.

604 contain software objects for storing and manipulating Receiver ID's and associated information. This may have a many-to-many linkage with users contained within 605. It is also possible for a device not to have a user.

605 contains software objects for storing and manipulating User Profiles and associated information.

606 contains software objects for storing and manipulating Transmitter IDs and associated information. This may have a many-to-one linkage with providers contained within 607. It is also possible for a device not to have a provider.

607 contains software objects for storing and manipulating Provider Profiles and associated information.

608 contains software objects for storing and manipulating Service Logs, providing monitoring through the API 602 and standard SNMP, and for generating reports through the API 602.

609 contains software objects for storing and manipulating Coordinator Service Peers and Authorities and associated information.

It should be appreciated that the particular implementations shown and described herein are illustrative of the invention and its best mode and are not intended to otherwise limit the scope of the present invention in any way. Indeed, for the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

In the specification, the term “media” means any nontransient medium that can record data therein. The term “media” includes, for instance, a disk shaped media for such as CD-ROM (compact disc-read only memory), magneto optical disc or MO, digital video disc-read only memory or DVD-ROM, digital video disc-random access memory or DVD-RAM, a floppy disc, a memory chip such as random access memory or RAM, read only memory or ROM, erasable programmable read only memory or E-PROM, electrical erasable programmable read only memory or EE-PROM, a rewriteable card-type read only memory such as a smart card, a magnetic tape, a hard disc, and any other suitable means for storing a program therein.

A recording media storing a program for accomplishing the above mentioned apparatus maybe accomplished by programming functions of the above mentioned apparatuses with a programming language readable by a computer or processor, and recording the program on a media such as mentioned above.

A server equipped with a hard disk drive may be employed as a recording media. It is also possible to accomplish the present invention by storing the above mentioned computer program on such a hard disk in a server and reading the computer program by other computers through a network.

As a computer-processing device, any suitable device for performing computations in accordance with a computer program may be used. Examples of such devices include a personal computer, a laptop computer, a microprocessor, a programmable logic device, or an application specific integrated circuit.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A system for at least one of metering wireless power and tiered delivery of wireless power, comprising:
a transmitter having a power transmitting device ID and configured to wirelessly power a device;
a receiver having a power receiving device ID and configured to wirelessly receive power from the transmitter; and
a coordinating system configured to manipulate the power receiving device ID and profiles and manipulate power transmitting device ID and profiles.

2. The system of claim 1, wherein the transmitter further comprises:
a receiver proximity detection device configured to detect the receiver;
an ID exchange mechanism configured to at least one of extract the power receiving device ID and provide the power transmitting device ID;
a transceiver configured to at least one of provide the power transmitting device ID, receive the power receiving device ID, and exchange data with the coordinating system;
at least one power emitter configured to wirelessly emit power to the receiver; and
a data processor and control assembly comprising a CPU and a memory, the data processor and control assembly configured to at least one of manage a user interface and maintain a rule set for service delivery.

3. The system of claim 1, wherein the receiver further comprises:
an ID exchange mechanism configured to at least one of provide the power receiving device ID and receive the power transmitting device ID; and
at least one power collector configured to wirelessly receive the power.

4. The system of claim 3, wherein the receiver further comprises at least one of:
a transceiver configured to at least one of receive the power transmitting device ID and provide data to the transmitter; and
a data processor and control assembly configured to at least one of manage a user interface and maintain a rule set for service delivery.

5. The system of claim 2, wherein the transmitter is configured to at least one of accept requests for power from a device and accept instructions to charge the device from the coordinating system.

6. The system of claim 5, wherein the transmitter is configured to authorize the requests by one or more of special IDs, tokens, credit/debit mechanisms, account number, serial, and device numbers.

7. The system of claim 5, wherein the transmitter is configured to provide pricing, load levels, available times, and negotiate an agreed operating level with the receiver based at least in part on the request.

8. The system of claim 5, wherein the transmitter provides additional signals to the receiver to vary a behavior of the receiver.

9. The system of claim 8, wherein the additional signals incorporate information from one or more of a user, a device and a provider profile.

10. The system of claim 5, wherein the transmitter further comprises a fraud detection module configured to monitor a load at the transmitter and compare it with a reported load from receivers.

11. A transmitter configured to wirelessly provide power to a device comprises:
a receiver proximity detection device configured to detect the device;
an ID exchange mechanism configured to at least one of extract a device ID of the device and provide a transmitter ID;
a transceiver configured to at least one of provide the transmitter ID, receive the device ID, and exchange data with a coordination system;
at least one power emitter configured to wirelessly provide power to the device; and
a data processor and control assembly comprising a CPU and memory, the data processor and control assembly configured to at least one of manage a user interface and maintain a rule set for service delivery.

12. The transmitter of claim 11, further comprising a proximity detector configured to detect a distance to the device.

13. A device configured to wirelessly receive power comprising:
an ID exchange mechanism configured to at least one of provide a device ID associated with the device and receive a transmitter ID; and
at least one power collector configured to wirelessly receive power for the device.

14. The device according to claim 13, further comprising:
a transceiver configured to at least one of receive a transmitter ID and exchange data with a coordination system; and
a data processor and control assembly configured to at least one of manage a user interface and maintain a rule set for service delivery.

15. The device according to claim 13, wherein the ID exchange mechanism is a passive element.

16. The device according to claim 15, wherein the passive element is a barcode.

17. A method for wirelessly providing energy, comprising:
accepting a request for power from a device;
authorize the request for power;
provide energy to a the device; and
record usage data of the device.

18. The method of claim 17, further comprising:
monitoring a load at a transmitter;
comparing the monitored load with reported load from the device; and
identifying fraud based at least in part on the compared loads.

19. The method of claim 17, further comprising tuned frequency hopping based on a predetermined pattern known to authorized receivers.

20. The method of claim 17, wherein the request for power comprises at least one of a duration and a wattage level.

21. The method of claim 17, wherein the authorization comprises one or more of an ID, a token, a credit/debit mechanisms, an account number, a serial number, and a device number.

22. The method of claim 17, further comprising providing at least one of a price, a load level, and an available time for providing the energy.

23. The method of claim 22, further comprising negotiating an agreed operating level with device based at least in part on the at least one of the pricing, the load level, and the available time for providing the energy.

24. The method of claim 17, further comprising billing for the provided energy based at least in part on the usage data.
